(19) United States
(12) Patent Application Publication
(10) Pub. No.: US 2024/0362698 A1
(43) Pub. Date: Oct. 31, 2024

(54) SYSTEM AND METHOD FOR DYNAMICALLY RECOMMENDING FOOTWEAR SIZE, AND FOOTWEAR THEREOF

(71) Applicant: UNIVERSITY COLLEGE DUBLIN, Dublin (IE)

(72) Inventors: Ricardo Simon Carbajo, Dublin (IE); Alan Power, Dublin (IE)

(21) Appl. No.: 18/687,575

(22) PCT Filed: Aug. 30, 2022
(86) PCT No.: PCT/EP2022/074130

§ 371 Date: Feb. 28, 2024

(30) Foreign Application Priority Data
Aug. 30, 2021 (GB) 2112347.6

(51) Int. Cl. G06Q 30/0601

(52) U.S. Cl. CPC G06Q 30/0631

(57) ABSTRACT

A computer implemented method and system for dynamically recommending footwear size includes receiving a plurality of images of a foot of a user during a current scan of the user foot, analysing the plurality of images to generate a 3D foot profile of the user, determining a foot size of the user based on the 3D foot profile, predicting a foot growth pattern of the user based on the 3D foot profile, and a user profile, recommending one or more footwear size for the user based on the foot size, the predicted foot growth pattern, one or more footwear brands and models, and predicting a time of next scan of the foot based on the recommended footwear size and the predicted foot growth pattern.

### FIELD

The present disclosure relates to a system and method for dynamically recommending footwear size and footwear.

### BACKGROUND

Typically, correct footwear fitting is acknowledged as being vitally important, as incorrectly fitted footwear may be linked to foot pathology. Many parents face difficulty in keeping a track of when to change size of their child's footwear. Research in this area shows that 2 out of 3 children wear ill-fitted footwear, where more than half of the children wear smaller sized footwear. This can have significant health implications both in long term and short term as improperly fitted shoes may cause hallux valgus, which is a foot deformity that happens when the big toe starts to angle inward, causing a swollen lump just below the big toe. Improperly fitted shoes may also lead to posture and back issues in users.

From shoe retailer's perspective, online shoe sales are generally lower as compared to sales of other items, such as clothes. A lot of this can be attributed to uncertainly around fit. The returns of shoes are also high, because of bad fitting and ordering of incorrect shoe size. Also, shopping at stores may be costly and inefficient.

There exist many solutions that recommend footwear size for adults and children. Some of them require the inclusion of a reference object, for example, a paper print out, or a coin to recommend footwear size. However, they are not very accurate and reliable. Other solutions facilitate measuring and recommending footwear size based on multiple pictures captured using front facing camera, however, this process is very cumbersome for the end user. Some other solutions recommend shoe size for the user based on their previous purchase(s). However, they do not provide any personalized recommendations. Moreover, none of the existing solutions focus or has expertise on recommending footwear size for children.

EP 3866097A1 discloses a foot length information management system that discloses a reference device to capture images of a feet of a user, and requires an operator to have experience on how to use the reference device to position the feet before the user. Therefore, it is a very manual process where the foot has to be well placed in the measuring reference device which uses a set of marks for the imager to detect the length. Also, said system uses image processing of one image to identify the foot length, and does not take into account of other foot parameters such as foot width, ankle width, foot height, and hallux angle, leading to an inaccurate assessment of growth. Also, said systems use pre-calculated growth curves based on statistics analysis where one or more of them are selected according to age and foot length of the user, and then fine-tuned with gender and race if data exist for that growth curves. However, there is not much detail provided on how those curves are generated or updated, and the mechanism is based on static data.

WO 2012/103857 solely focuses on the estimation of child's feet growth, and only takes length into account, obviating the width as a key measurement for the good health of children's feet. Said application proposes growth as a set of regression formulas, derived from the Carlsberg growth model, which is an empirical static model based solely on the length of 2000 children aged from 3 to 18 years. This represents a risky bias as the number in the sample set may not be representative, is static and only depends on two parameters.

Both the above-mentioned cited art fail to dynamically calculate and update foot growth of a user based on new and historical data pertaining to the phenotype and preferences of the user and other similar users and the shoe manufacturers details worldwide. Also, they fail to generate any intermediate alerts for the user to plan replacement of shoes or get a scan at any time or any place to reduce risk and inaccuracies. Also, there is no way, existing foot growth mechanisms of both the cited documents can deal with missing data of the subject, e.g. when a recommended scan could not be completed, and still provide a proxy prediction based on similar user profiles. Also, such mechanisms do not take into account of the variability in shoe sizes for different manufacturers for a given foot size.

Hence, in view of the above, there is a need for system and method for recommending both footwear size and footwear recommendation system, that overcomes the problems associated with existing solutions, and that has a primary focus on dynamically recommending footwear size for children and thus supporting parents on the journey to healthy footcare for their children.

### SUMMARY

According to the invention there is provided, as set out in the appended claims, a computer implemented method for dynamically recommending footwear size that includes receiving a plurality of images of a foot of a user during a current scan of the user foot, wherein the scan is performed through a mobile computing device, analysing the plurality of images to generate a 3D foot profile of the user, determining a foot size of the user based on the 3D foot profile, predicting a foot growth pattern of the user using machine learning techniques based on the 3D foot profile, and user profile from the current and one or more previous scans of the user and one or more other users, recommending one or more footwear sizes for the user based on at least one of: the foot size, the predicted foot growth pattern, one or more footwear brands and one or more footwear models, and predicting a time of next scan of the foot based on the recommended footwear size and the predicted foot growth pattern of the user and one or more other users.

In one embodiment of the present invention, the 3D foot profile includes at least one of: a length, a width, an ankle width, a foot height, and a hallux angle of the foot of the user.

In one embodiment of the present invention, the method includes classifying the 3D foot profile into one of a plurality of pre-defined categories.

In one embodiment of the present invention, the method includes determining an age and a gender of the user based on the plurality of images, wherein the user profile includes at least one of: the age and the gender.

In one embodiment of the present invention, the method includes recommending a plurality of footwear to the user by searching in a pre-defined footwear inventory based on the recommended footwear size, the 3D foot profile and the user profile, wherein the plurality of footwear is arranged for viewing by the user in a decreasing order of probability of being a good fit to the foot.

In an embodiment of the present invention, the computer-implemented method includes recommending the plurality of footwear based on the first through fifth inputs, the first input including the foot size of the user, the second input including dimensions of manufacturer's footwear, the third input including properties of manufacturers' shoes including type, colour, material, brand, id of manufacturer, and inventory data, the fourth input including user profile of the user, including phenotype and preferences including purchase data from activity and feedback of past purchases, and the fifth input including user profile of the one or more other users, including phenotype and preferences including the purchase data from activity and feedback of past purchases.

In an embodiment of the present invention, the recommending comprises a first step of employing a feet-shoe dimension matching algorithm based on the first and second inputs to generate a first list of shoe recommendations for the user.

In an embodiment of the present invention, the computer-implemented method includes comparing 3D profile of a shoe with the 3D foot profile to generate the first list of shoe recommendations for the user.

In an embodiment of the present invention, the recommending comprises a second step of employing a profile-shoe matching algorithm based on the third and fourth inputs to reduce down the first list of the shoe recommendations for the user.

In an embodiment of the present invention, the recommending comprising a third step of querying a user profile model previously trained with the fifth input using clustering-based machine learning techniques to create a structure of user profiles with observations aggregating features of the user phenotype, preferences, feet dimensions and shoes purchasing status, to obtain a list of user profiles ranked by similarity.

In an embodiment of the present invention, the recommending comprises a fourth step of matching and ranking the reduced first list against the list of user profiles to recommend the plurality of footwear.

In one embodiment of the present invention, the computer-implemented includes predicting the footwear inventory based on the recommended plurality of footwear.

In one embodiment of the present invention, the computer-implemented includes calculating a risk associated with changing footwear size of the user based on the 3D foot profile, and the predicted foot growth pattern, wherein the risk increases with each day subsequent to day of the current scan, and generating an alert for the user to perform the next scan, when the calculated risk exceeds a predetermined risk threshold.

In one embodiment of the present invention, the computer-implemented includes calculating a risk that the user is wearing an incorrectly fitted footwear, based on the worn footwear, 3D foot profile, and the predicted foot growth pattern, wherein the risk increases with each day subsequent to day of the current scan, and generating an alert for the user when the calculated risk exceeds a predetermined risk threshold.

In one embodiment of the present invention, the method includes providing a user interface on the user computing device so as to enable a user to capture the plurality of the images of the foot through a camera of the user computing device, and enable the user to provide one or more details to generate the user profile.

In one embodiment of the present invention, the computer-implemented includes providing the user interface so as to enable the user to provide their feedback, and processing the feedback to revise the recommended footwear.

In one embodiment of the present invention, the computer-implemented includes performing longitudinal analysis of foot growth between current and next scans to predict foot growth and development of the user, and detect an anomaly in the foot growth by analysing the foot growth in respect of a 3D foot profile and footwear size applicable for the age and gender of the user.

In one embodiment of the present invention, the computer-implemented includes generating a three-dimensional model of a footwear for the user based on the 3D foot profile, and the user profile.

There is also provided a system for recommending footwear size, that includes a foot profiling module configured to receive a plurality of images of a foot of a user during a current scan of the user foot, analyse the plurality of images to generate a 3D foot profile of the user, and determine a foot size of the user based on the 3D foot profile. The system further includes a foot growth pattern module configured to predict a foot growth pattern of the user based on the 3D foot profile, and a user profile. The system further includes a recommendation module configured to recommend one or more footwear sizes for the user based on the foot size, the foot growth pattern and one or more footwear brands and one or more footwear models. The system further includes a prediction module configured to predict a time of next scan of the foot based on the recommended footwear size and the foot growth pattern.

In one embodiment of the present invention, the system further includes a user profiling module that is configured to: classify the 3D foot profile into one of a plurality of pre-defined categories and determine an age and a gender of the user based on the plurality of images, wherein the user profile includes at least one of: the age, the height, the ethnicity, and the gender.

In one embodiment of the present invention, the recommendation module is further configured to recommend a plurality of footwear to the user by searching in a pre-defined footwear inventory based on the recommended footwear size, the 3D foot profile and the user profile, wherein the plurality of footwear is arranged for viewing by the user in a decreasing order of probability of being a good fit to the foot.

In one embodiment of the present invention, the prediction module is further configured to predict the footwear inventory based on the recommended plurality of footwear.

In one embodiment of the present invention, the system further includes a risk calculation module that is configured to calculate a risk that the user is wearing an incorrectly fitted footwear, based on the worn footwear, 3D foot profile, and the predicted foot growth pattern, wherein the risk increases with each day subsequent to day of the current scan, calculate a risk associated with changing footwear size of the user based on the 3D foot profile, and the predicted foot growth pattern, wherein the risk increases with each day subsequent to day of the current scan, and a notification module that is configured to generate an alert for the user when the calculated risk exceeds a predetermined risk threshold.

In one embodiment of the present invention, the system further includes a user interface module that is configured to provide a user interface on the user computing device so as to enable a user to capture the plurality of the images of the foot through a camera of the user computing device, and enable the user to provide one or more details to generate the user profile.

In one embodiment of the present invention, the recommendation module is configured to receive the user feedback through user interface, and process the feedback to revise the recommended footwear.

In one embodiment of the present invention, the foot growth pattern module is further configured to perform longitudinal analysis of foot growth between current and next scans to identify foot growth and development of the user, and the risk calculation module is configured to detect an anomaly in the foot growth by analysing the foot growth in respect of a footwear size applicable for the age and gender of the user.

In one embodiment of the present invention, the system further includes a model generating module that is configured to generate a three-dimensional model of a footwear for the user based on the 3D foot profile, and the user profile.

There is also provided a computer program comprising program instructions for causing a computer program to carry out the above method which may be embodied on a record medium, carrier signal or read-only memory.

Various embodiments of the present invention provide a footwear recommendation platform that dynamically provides personalised recommendations of footwear size and footwear to a customer, and reduce their purchase of improperly fitted footwear. The footwear recommendation platform enhances the user experience through their recommendations, and also provide data dashboards to the footwear retailers to provide customer insights. The footwear recommendation platform is accurate, reliable, does not require a reference object marked with measuring points to capture length of foot for recommending footwear size, and is child focussed. The footwear recommendation platform generates a 3D object of the foot without the reference object, and measure 3D dimensions of the foot including length, width, ankle width, foot height, and a hallux angle of the foot of the user, as compared to existing systems that employ a 1D length-based static approach.

The footwear recommendation platform employs machine learning based foot growth algorithms to dynamically identify when a child may be at risk of changing footwear size or wearing improperly fitted footwear, and sends appropriate notifications to parents. The footwear recommendation platform may be integrated into existing online (e-commerce websites) and offline footwear shopping systems, thereby increasing overall sales, reducing returns, and increasing marketing opportunities.

The foot growth algorithms of the present invention are truly dynamic that learn from new and historical data from users (foot measurement parameters and phenotype parameters) using machine learning techniques. They are also capable of learning from different timelines between scans as users would scan at different points in time and provide better intermediate data points to improve the accuracy of growth as more data is received. The footwear recommendation platform employs a continuous update system, providing the Risk of Wearing Current Shoes metric based on how much is left for the replacement of shoes according to foot growth estimations, phenotype parameters, and potential inaccuracies in the measurement, thus prompting for intermediate scans (at any point and place as it is a portable system) to validate estimations (to reduce the risk of spurious feet growth of the user), as opposed to the existing systems which only measure in stores and provide one estimation of time to replace the shoe calculated. Thus, the approach of the present invention is not tied to a set of growth curves on particular features but rather it can keep on learning from multiple features and can start working and learning from any population in the world using the same system, thus learning new growth patterns. This way, the growth algorithm can deal with missing data of the subject, e.g. when a recommended scan could not be completed, and still provide a proxy prediction based on similar user profiles. Also, the footwear recommendation system has a mechanism for correcting for errors in growth predictions based on: i) an instant and portable mechanism for foot scanning which can gather the 3D dimensions of the feet when required using a mobile device and recalibrate the growth, and ii) a system for the subject to provide feedback to account from errors in the measuring system. Both mechanisms enable the system to learn from errors and this is dynamically propagated and updates the adaptive model periodically for the benefit of new users.

### BRIEF DESCRIPTION OF THE DRAWINGS

The invention will be more clearly understood from the following description of an embodiment thereof, given by way of example only, with reference to the accompanying drawings, in which:—

FIG. 1 illustrates an environment, wherein various embodiments of the present invention can be practiced;

FIG. 2 illustrates various exemplary screenshots of the user terminal implementing the footwear recommendation system of FIG. 1;

FIG. 3 is a flowchart illustrating a method for recommending footwear size, in accordance with an embodiment of the present invention; and

FIGS. 4A and 4B illustrate a detailed method for recommending footwear size and footwear for the user, in accordance with an embodiment of the present invention.

### DETAILED DESCRIPTION OF THE DRAWINGS

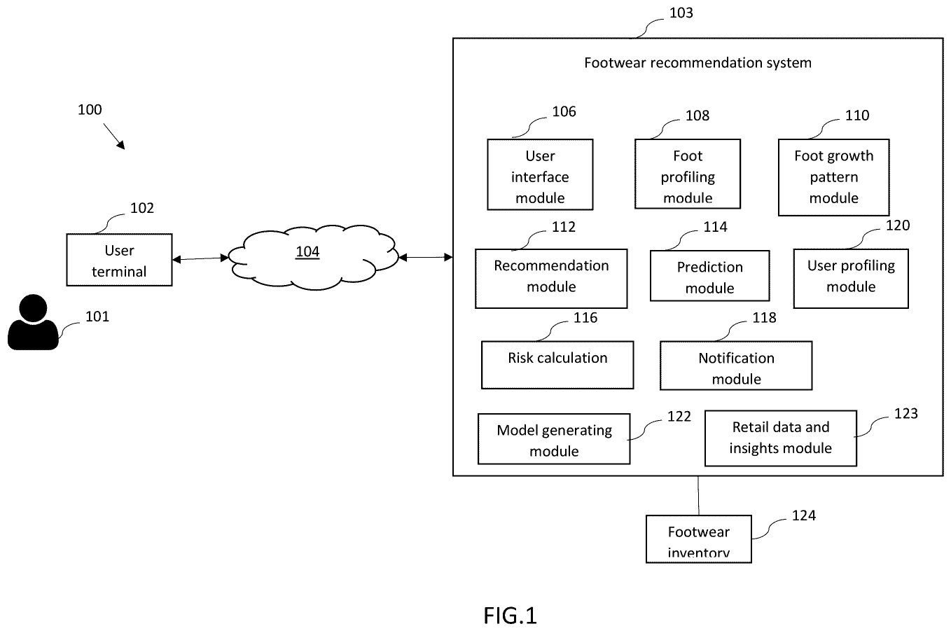

FIG. 1 illustrates an environment 100, wherein various embodiments of the present invention can be practiced. The environment 100 includes a user terminal 102, and a footwear recommendation system 103 communicatively coupled to each other through a communication network 104. The communication network 104 may be any suitable wired network, wireless network, a combination of these or any other conventional network, without limiting the scope of the present invention. Few examples may include a Local Area Network (LAN), wireless LAN connection, an Internet connection, a point-to-point connection, or other network connection and combinations thereof.

The user terminal 102 may be a user computing device, examples of which include, but are not limited to a personal computer, a mobile phone, a portable computing device, and the like. The user terminal 102 may operate as a client device that request for footwear size recommendations, and the footwear recommendation system 103 may operate as a server device that fulfil user requests of the footwear size recommendations. In one example, the user 101 of the user terminal 102 may be a customer looking for footwear recommendations for themselves, or for their children. In another example, the user 101 may be a footwear retailer who may request for footwear size recommendations for customer at their outlets. In yet another example, the user 101 may be a footwear manufacturer who generally wants insights on footwear size recommendations for manufacturing purpose. The user terminal 102 may generate requests for footwear recommendations through an application of the footwear recommendation system 103, world wide web, social media applications, marketing applications, an e-commerce platform selling footwear, and the like.

Although the footwear may include a shoe, a flip-flop, a sandal, a sports shoe, and the like, in the context of the present disclosure, the footwear is interchangeably referred to as shoe, and the footwear recommendation system 103 may be interchangeably referred to as shoe recommendation system 103. In an embodiment of the present invention, the footwear recommendation system 103 includes a user interface module 106, a foot profiling module 108, a foot growth pattern module 110, a footwear recommendation module 112, a prediction module 114, a risk calculation module 116, a notification module 118, a model generating module 120, a user profiling module 122, and a retail and data insights module 123.

The user interface module 106 provides a user interface on the user terminal 102 so as to enable the user to provide one or more details to generate a user profile. The user interface module 106 enables the user 101 to register and create an account with the footwear recommendation system 103 based on the user profile. The user profile may include a name, an age, a gender, a location, and a footwear preference of the user. The user profile may also pertain to certain category of the users. When the user 101 is a shoe retailer/manufacturer, they may manage an account with the footwear recommendation system 103 on a monthly/yearly subscription basis.

The user interface module 106 may further enable the user 101 to capture a plurality of images of their foot through a camera of the user terminal 102 during a current scan of the foot. In the context of the present disclosure, a scan is referred to as a process of capturing multiple images of a foot for the purpose of generating a 3D foot profile, and the current scan is referred to as a scan performed at a current time instant.

The foot profiling module 108 receives the plurality of images of the foot from the user terminal 102 during each scan of the user foot, and analyse the plurality of images to generate a 3D foot profile of the user. The 3D foot profile is typically a 3D model of foot that includes, but is not limited to: a length, a width, an ankle width, a foot height, and a hallux angle of the foot of the user. The foot profiling module 108 may be able to generate a 3D model that may include all the possible measurements of the user foot. The foot profiling module 108 uses 3D data processing and computer vision to generate the 3D foot profile. While regular scanning is not required for an adult, the 3D profile information is hugely valuable to the retailer in being able to provide a better customer experience and better insights. It is to be noted, that the generation of 3D foot profile is not limited to shoe stores, and can be performed at any place at any time, using the mobile phone device.

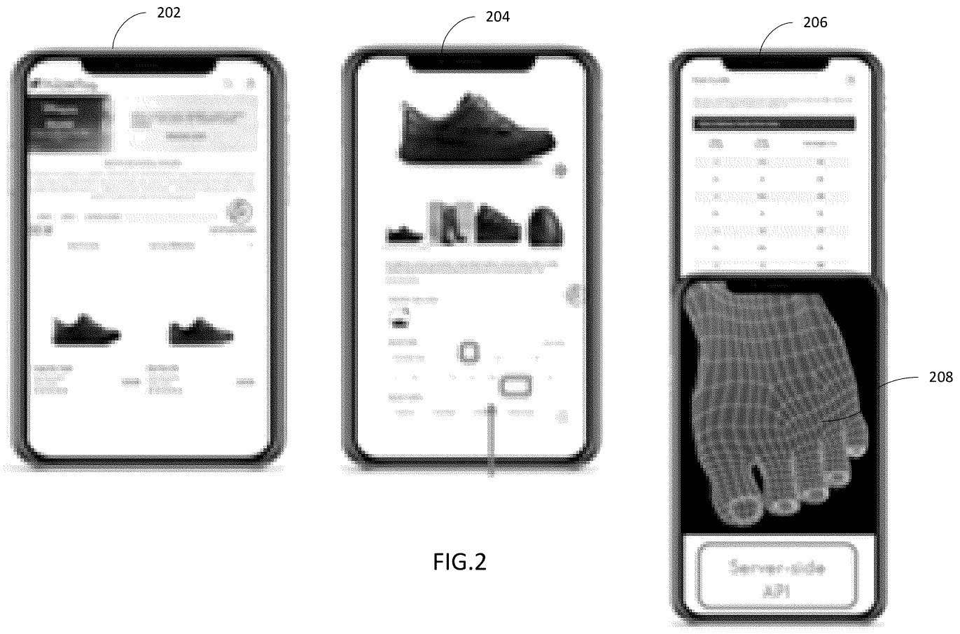

FIG. 2 illustrates first through third exemplary screenshots 202, 204 and 206 of the user terminal 102 implementing the footwear recommendation system 103. The first screenshot 202 shows an online store of a footwear retailer, which shows various shoes that can be bought by the user. The second screenshot 204 shows a footwear selected by the user. The third screenshot 206 shows an exemplary 3D foot profile 208 generated based on the images captured by the user terminal 102. It may be noted that the exemplary 3D foot profile 208 may be viewed by a remote user, such as a shoe fitter for the purpose of assisting with the shoe selection remotely.

Referring back to FIG. 1, the foot profiling module 108 may further determine a foot size of the user based on the 3D foot profile, without requiring a reference object. The foot profiling module 108 converts the extracted measurements of the 3D foot profile into a current shoe size of the user. In an example, the foot profiling module 108 generates the current shoe size based on Mondopoint shoe sizing scale.

Additionally, or optionally, the foot profiling module 108 may convert a shoe size of the user between different measuring scales (Mondopoint—US/UK/EU/etc). It may be noted that Mondopoint is to the millimetre, in 5 mm ranges, while the international sizes are size ranges calculated in “barleycorns” or “paris points”.

The foot growth pattern module 110 predicts a foot growth pattern of the user based on the 3D foot profile, and the user profile. The foot growth pattern module 110 may predict the foot growth of the user at a given time point, using machine learning techniques based on the 3D foot profile, and a user profile from the current and one or more previous scans of the user and one or more other users. In an embodiment of the present invention, the foot growth pattern module 110 performs longitudinal analysis of foot growth between two subsequent scans to identify foot growth and development of the user. In an example, the two subsequent scans may include a current scan at t=0 and a next scan at t=3 months from the current scan. The longitudinal analysis is particular useful for growing children, as their foot is in growing stage, and foot size changes frequently. Additionally, the foot growth pattern module 110 may dynamically predict a date and time of next scan based on 3-D foot profile of the user, and also data from the phenotype of the subject such as age, height, ethnicity, etc. This approach is adaptable as it permits the addition of multiple features.

The mechanism to model such an adaptive foot growth pattern module 110 proposes a representation of the aforementioned features/parameters, both foot scanning parameters, and phenotype parameters, in an n-dimensional space, such that each instance is composed of the parameters of the current scan, noted as S, and the previous scan, noted as S′, where the dates of the scans may be included as part of the phenotype parameters, i.e. age in days. Once the system is modelled in such a way, updates can easily occur to the different instances (S, S′) in the space. The foot growth pattern module 110 may use clustering machine learning techniques, e.g. k-means or DBSCAN, to locate the closer S′ subset in the model with respect to a query Sq. It would analyse from the set of proposed close neighbours the similarity with respect to the query observation based on an aggregated distance metric in the n-dimensional space which may need to be within a certain threshold. This threshold would evolve as more data is generated and would serve to estimate accuracy of the prediction depending on how close the instances are in the multidimensional space. The closer S′ instances w.r.t S_{q} within the threshold distance may be used to calculate short-time linear extrapolations that may create an aggregated set of daily growth values which may depend on the inter-scan distances available in the n-dim space. Based on the point at which S_{q} is in the aggregated set of daily growth values, a set of daily forecasted predictions may be provided together with an associated confident value. This confident value may be another mechanism introduced as part of the growth estimation model to indicate the accuracy of the growth based on existing data and the distance to similar instances, and may also be used in the calculation of the Date of changing footwear size and the risk of wearing current shoes to alert the user of a change in footwear or a required scan to increase accuracy. Note that S_{q} may be inserted in the n-dim space and may be linked to previous data if and when it is available for the subject, or modified by the subject if an error is reported. The system may be initially bootstrapped with instances provided by expert foot fitters which may organically evolve as the system receives new data and corrects itself.

The recommendation module 112 recommends one or more footwear sizes for the user based on at least one of: the foot size, the foot growth pattern and one or more footwear brands and footwear models, as the footwear sizes may be different for different footwear brands and models. The recommendation module 112 is brand specific and even model (footwear within a brand) specific, thus providing size recommendations by model, and also matching groups of individual user profiles to model and brand preferences. This may help recommending future preferences and may improve over time with the more data collected.

After the current foot size for a user has been established, the recommendation module 112 recommends the shoe size for purchase by the user 101. This is relevant for children as it takes into account of their foot growth pattern.

Further, the prediction module 114 predicts a date and time of next scan of the foot based on the recommended footwear size and the foot growth pattern. Based on size recommendations and growth algorithms, the prediction module 114 approximates when the next scan is required and/or inform the user 101 when to check again. This helps to ensure the health of the child users, while also stimulate further commercial activity. The prediction module 114 also takes seasonal difference into consideration. In an example, a parent purchasing school footwear may expect it to last a full school year, and a scan may be recommended after one school year.

Additionally, the recommendation module 112 may recommend a plurality of footwear to the user 101 by searching in a footwear inventory 124 based on the recommended footwear size, the 3D foot profile and the user profile. The recommendation module 112 may also recommend an alternative when a match is not available in the inventory 124. The footwear inventory 124 may belong to a single external footwear retailer/manufacturer. Alternatively, the footwear inventory 124 may include all the footwear inventory available on world wide web. Alternatively, the footwear inventory 124 may be a dedicated inventory of the footwear recommendation system 103.

Additionally, the recommendation module 112 may recommend the footwear considering a brand of footwear. In an example, for profile X, a size 5 in Nike® might have a 66% fit probability, but a size 5 in Adidas® may have a 70% fit probability.

The recommendation module 112 may employ a shoe matching rules engine for searching in the footwear inventory 124 and recommending an ideal shoe for the user 101 within the inventory 124. The shoe matching rules engine perform general mapping of established profile categories to footwear preferences. The recommendation module 112 may recommend footwear to the user 101 at the time of current scan. Alternatively, the recommendation module 112 may send footwear recommendations to the user at a later stage, when the footwear inventory 124 is changed/updated.

Additionally, the recommendation module 112 may display the plurality of footwear on the user interface of the user terminal 102 in a decreasing order of probability of being a good fit to the foot. The recommendation module 112 displays a list of shoes in which the best fit shoe is displayed at the top.

The recommendation module 112 provide not only the correct size in terms of feet and shoe dimensions but also fine-tune the recommendations based on the phenotype and preferences of the user and other similar users and the shoe manufacturers details. In an embodiment of the present invention, the recommendation module 112 receives first through fifth inputs. The first input includes dimensions of recent scan of user/kids' feet. The second input include dimensions of manufacturer's shoe. The third input includes properties of manufacturers' shoes including type, colour, material, brand, id of manufacturer, inventory data, etc. The fourth input includes user profile, including phenotype and preferences (colour, brands, etc) including the purchase data from activity and feedback of past purchases. The fifth input includes all user profiles, including phenotype and preferences (colour, brands, etc) including the purchase data from Activity and Feedback of past purchases.

The recommendation module 112 performs a first step of employing the feet-shoe dimension matching algorithm which may use first and second inputs to optimise on both feet of the user at the same time, in two ways. One is basic optimisation in which optimisation is performed based on foot length and foot width against length and width provided by a manufacturer. Another is deep optimisation for deep accurate matching, where health problems can exist, in that comparison of 3D of last shoe (when available from manufacturer) is performed against generated 3D model of user's feet, including i) the extraction of length, width, ankle width, foot height, hallux angle, and ii) using volumetric comparison techniques for selection optimum matching. The feet-shoe dimension matching algorithm may select the set of available shoes from the search space based on matching dimensions within predefined thresholds.

The recommendation module 112 then performs a second step by employing third and fourth inputs, and using the profile-shoe matching algorithm to further reduce the subset of potential shoes selected by the feet-shoe dimension matching algorithm. This algorithm can be configured to include a subset, ranges and tolerance levels in the shoe preference parameters to control the pruning process.

The recommendation module 112 then performs a third step which includes querying a user profile model which has been previously trained with the fifth input using clustering-based machine learning techniques to create a structure of similar user profiles with observations aggregating features of the user phenotype, preferences, feet dimensions and shoes purchasing status (e.g. shoes purchased and not returned). The user profile model may re-trained periodically as data from users is received. The user profile model may be queried with the current user profile data, fourth input, feet dimensions, first input, and would return a list of user profiles ranked by similarity.

The recommendation module 112 finally matches and ranks the subset produced in the second step against that subset generated in the third step such that a ranking may be produced where the top shoes are recommended to the user.

Additionally, the recommendation module 112 receives the user feedback through the user interface and process the feedback to revise the footwear to be recommended in future. In an embodiment of the present invention, the shoe matching rules engine processes various feedback both direct (from consumers, e.g. satisfaction) and indirect (from retailer, e.g. returns) to evaluate their footwear recommendations. Thus, through machine learning, the shoe matching rules engine learns from previous success and failures. Although, not shown, the footwear recommendation system 103 may include a feedback module to manage returns, fit tracking, ecommerce data, and purchase tracking of the user 101. Thus, the shoe matching rule engine improves over time through Machine Learning based upon previous purchases. In an example, when users A and B both have a similar 3D foot profile, and both had success with Footwear X, then when a new user C has a 3D foot profile similar to that of A and B, then footwear C may be recommended to the user C. Thus, the footwear recommendation system 103 is dynamic and evolves with more data being received so the system learns over time. This is achieved by using historical data from the same subject but also from similar subjects which are used as a proxy to predict and improve the accuracy of the prediction system. This way, the footwear recommendation system 103 can deal with missing data of the subject, e.g. when a recommended scan could not be completed, and still provide a proxy prediction based on similar user profiles. It will be appreciated that the machine learning can include other variables for the shoe matching rule engine such as fitter expertise, individual preferences, seasonal, manufacturer data, stock data, return data and other data that is feed into the show matching rule engine to recommend the ideal footwear.

Thus, the system has a mechanism for correcting for errors in growth predictions based on: i) an instant and portable mechanism for foot scanning which can gather the 3D dimensions of the feet when required using a mobile device and recalibrate the growth, and ii) a system for the subject to provide feedback to account from errors in the measuring system; both mechanisms enable the system to learns from errors and this is dynamically propagated and updates the adaptive model periodically for the benefit of new users.

The risk calculation module 116 calculates a risk that the user 101 is wearing an incorrectly fitted footwear, based on the worn footwear, 3D foot profile, and the foot growth pattern, wherein the risk increases with each day subsequent to day of the current scan. Additionally, or optionally, the risk calculation module 116 calculates a risk associated with changing footwear size of the user 101 based on the 3D foot profile, and the foot growth pattern, wherein the risk increases with each day subsequent to day of the current scan. In other words, the risk calculation module 116 calculates a risk that the user 101 has changed shoe size today, and it is assumed that the risk would increase each day after the current scan. The risk calculation module 116 employs foot growth algorithm that monitors foot growth and warns the user 101 over time. It may be noted that the risk calculation is not done at time of scan, it is a variable calculated on an ongoing basis for every user, as with each day that passes, risk increases.

The risk calculation module 116 calculates risk of wearing current shoes which is based on how much is left for the replacement of shoes according to foot growth estimations, phenotype parameters, and potential inaccuracies in the measurement, thus prompting for intermediate scans (at any point and place as it is a portable system) to validate estimations. Thus, a continuous update system is provided, providing the aforementioned risk of wearing current shoes metric, in mobile device which alerts and gives time to the user to plan replacement of shoes or get a scan of its shows at any time to reduce risk and inaccuracies.

The notification module 118 generates an alert for the user when the calculated risk exceeds a predetermined risk threshold. The alert may be in form of an email, or a message reminding the user 101 that it is time to buy a new footwear and/or the present footwear is incorrectly fitted. This is particularly useful for children, as the risk calculation module 116 predicts growth patterns to determine when a child is at risk of changing shoe size and is potentially in need of new footwear.

Additionally, the notification module 118 notifies a predicted date and time of next scan of the foot to the user 101 through email/messages. Thus, the notification module 118 generate notifications for the user 101 and send frequent reminders thereto.

Additionally, the risk calculation module 116 may detect an anomaly in the foot growth by analysing the foot growth in respect of a 3D foot profile and a foot size applicable for the age and gender of the user. The risk calculation module 116 may be able to perform benchmarking on healthy foot growth. The variances within a scan in comparison to these benchmarks can be very useful in relation to early detection in foot health issues. In an example, for a girl child of age 7, if the present foot growth deviates largely from the applicable foot size, then it means that there may be some medical issue associated with her foot growth. In another example, an anomaly may be detected in a 3D foot profile when for instance, a hallus angle of a user foot is greater than 15 degrees. The risk calculation module 116 may also generate percentile charts for foot growth similar to the charts used for children weight and height to detect anomalies.

The notification module 118 may send a notification to the user 101 regarding detection of an anomaly in their foot growth pattern. The notification may also include a medical referral recommendation for treatment of the medical issue associated with the foot. The notification may be sent through an instant message, an email, a voice message, and the like.

The user profiling module 120 may automatically determine an age and a gender of the user based on the current scan. This is particularly useful, when the user 101 has not provided their age and gender. Also, the user profiling module 120 may use the longitudinal analysis of foot growth of the user 101 between subsequent scans to identify changes in foot growth and development of the user 101. The user profiling module 120 may further classify the 3D foot profile of the user 101 into one of a plurality of pre-defined categories. The pre-defined categories may be age based, location based, gender based, and/or shoe preference-based user groups. The user profiling module 120 may further facilitate grouping of different 3D foot profiles based on types, sizes and data over time to aggregate and to identify trends and support footwear recommendations.

The profile classification/grouping may facilitate consumer segmentation to facilitate marketing initiatives. In an example, a number of children within a user account and their approximate ages and frequency of purchase may be useful for targeting marketing initiatives for children of this age group. The profile classification/grouping further facilitates providing future footwear recommendations based upon the similar profile footwear preferences and successes. It may also help refine growth algorithms, and also perhaps support future uses such as progress due to orthotics, identify anomalies etc.

The model generating module 122 generates a three-dimensional model of a footwear for the user based on the 3D foot profile, and the user profile. In an example, the model generation module 122 may perform three-dimensional printing of tailored/personalized shoes for children based on the foot and user profiles.

The retail data and insights module 123 generate impact of usage of the footwear recommendation system 103 on multiple existing and new retailer Key performance indicators (KPIs). In the context of the present disclosure, the retailer is an online shoe retailer which implements the footwear recommendation system 103 for facilitating the users to buy from their online store. In one scenario, the retailer may integrate the footwear recommendation system 103 at their online store. Alternatively, the footwear recommendation system 103 may redirect a user to the online store of the retailer after recommending footwear size. Thus, when the footwear recommendation system 103 is integrated with the footwear inventory 124 of the retailer, more stock recommendations and calls to action can be provided to the retailer. The retail data and insights module 123 may further provide longitudinal footwear profile data about their customers to footwear retailers, and manufacturers. The retail data and insights module 123 may further generate a retail call to action (CTA) to understand why a consumer did not complete the purchasing journey, and/or why/why not did the consumer proceed with purchase after the scan. The retail data and insights module 123 use profile and consumer insights generated based upon user profiles for forecasting stock requirements. The retail data and insights module 123 generate data and insights to retailers around their consumers that they have never achieved before, supporting new personalised marketing campaigns, as well as guiding them to the ideal stock based upon that data.

In an embodiment of the present invention, the footwear recommendation system 103 may be communicatively coupled to various foot health monitoring applications for monitoring and advising on various foot health related issues. In an example, if a user is wearing an orthotic, his progress may be monitored remotely for medical purposes or for producers of orthotics by a foot health monitoring application.

In an embodiment of the present invention, the footwear recommendation system 103 may provide a shoe rental service for activities such as bowling. Nearly, 67 million people go bowling every year. Many borrow their bowling shoes and try on a number of uncomfortable old shoes before finding a good fit. The accurate scanning and fitting service provided by the footwear recommendation system 103 would enable adults and children to fit better, more hygienically.

In various embodiments of the present invention, the footwear recommendation system 103 may represent a computational platform that includes components that may be in a server or another computer system, and execute, by way of a processor (e.g., a single or multiple processors) or other hardware described herein. These methods, functions and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The footwear recommendation system 103 may include a processor that executes software instructions or code stored on a non-transitory computer-readable storage medium to perform method and functions that are consistent with that of the present disclosure. In an example, footwear recommendation system 103 may be embodied as a Central Processing Unit (CPU) having one or more Graphics Processing Units (GPUs) executing these software codes.

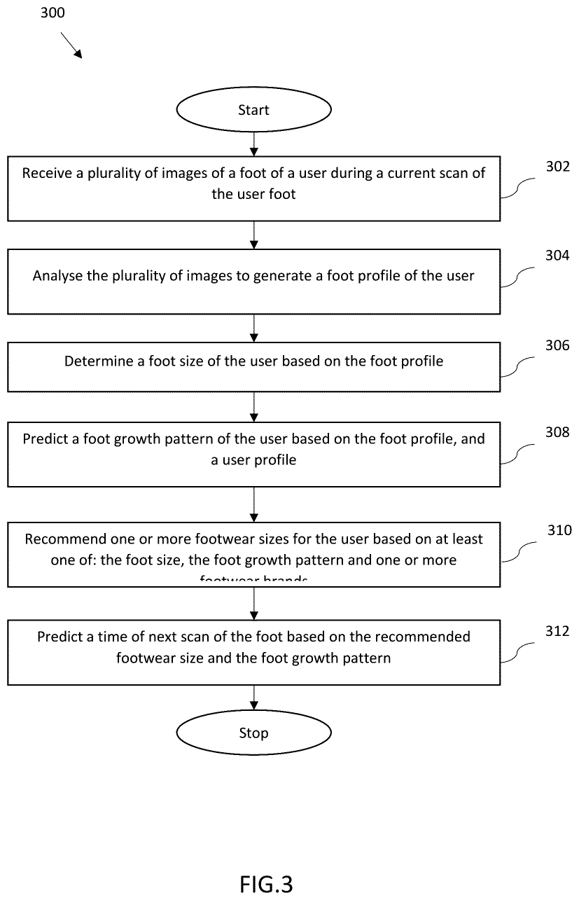

FIG. 3 is a flowchart illustrating a method 300 for recommending footwear size, in accordance with an embodiment of the present invention.

At step 302, the method 300 includes receiving a plurality of images of a foot of a user during a current scan of the user foot. In an embodiment of the present invention, the method 300 further includes providing a user interface on the user computing device so as to enable a user to capture the plurality of images of the foot through a camera of the user computing device, and enable the user to provide one or more details to generate the user profile.

At step 304, the method 300 includes analysing the plurality of images to generate a 3D foot profile of the user. In an embodiment of the present invention, the 3D data processing and computer vision techniques are being used to generate the 3D foot profile, and the 3D foot profile is typically a 3D model of foot indicating at least one of: a length, a width, an ankle width, a foot height, and a hallux angle of the foot of the user.

At step 306, the method 300 includes determining a foot size of the user based on the 3D foot profile. The foot size is determined by converting measurements of the 3D foot profile into a current shoe size of the user.

At step 308, the method 300 includes predicting a foot growth pattern of the user based on the 3D foot profile, and a user profile. In an embodiment of the present invention, the longitudinal analysis of foot growth is performed between two subsequent scans to identify foot growth and development of the user.

At step 310, the method 300 includes recommending one or more footwear size for the user based on at least one of: the foot size, the foot growth pattern and one or more footwear brands and models. After the current foot size for a user has been established, a footwear size is recommended for the user.

At step 312, the method 300 includes predicting a time of next scan of the foot based on the recommended footwear size and the predicted foot growth pattern. Based on size recommendations and growth algorithms, it is approximated that when the next scan is required and accordingly the user is informed.

The present disclosure may be implemented in the form of a computer programmable product for recommending footwear size. The computer programmable product includes a set of instructions, the set of instructions when executed by a processor causes the processor to perform the methods as discussed with FIG. 3.

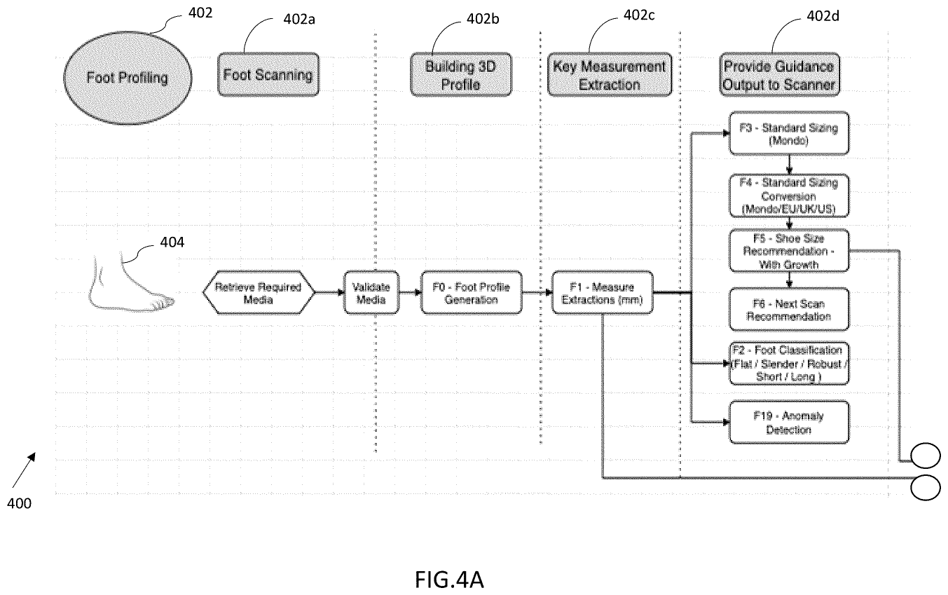

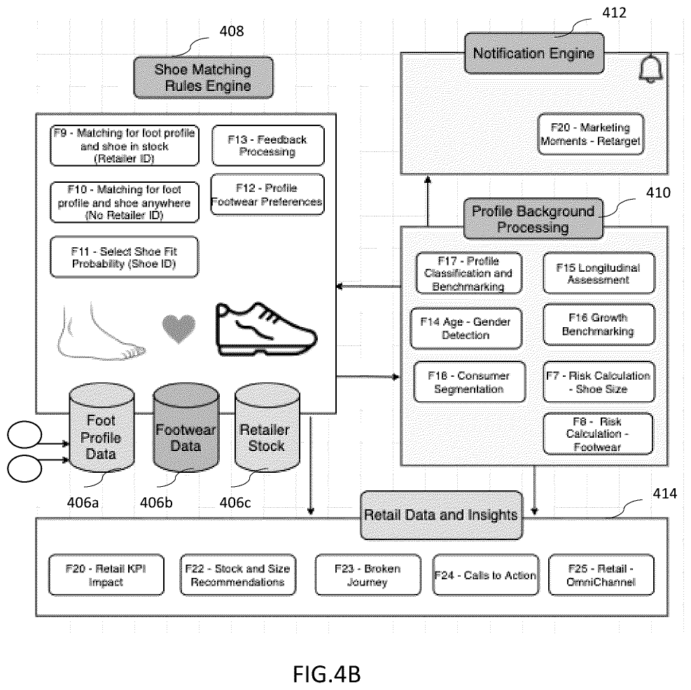

FIGS. 4A and 4B illustrate a detailed method 400 for recommending footwear size and footwear for the user, in accordance with an embodiment of the present invention.

The method 400 includes foot profiling 402 which includes foot scanning 402a, building 3D profile 402b, key measurement extraction 402c, and providing guidance output to scanner 402d.

The foot scanning 402a includes capturing a plurality of images of user foot 404 by a camera/scanner, retrieving required metadata, and validating metadata. The foot building 3D profile 402b includes ‘F0—Foot profile generation’, and the key measurement extraction 402c includes ‘F1—Measure extractions (mm)’. Upon execution of F1, further features are executed such as ‘F3—Standard sizing (mono)’; ‘F4—Standard sizing conversion (Mondo/EU/UK/US)’; F5—Shoe sizing recommendation (with growth); F6—Next scan recommendation; F2—Foot classification (Flat/Slender/Robust/Short/Long), and F19—Anomaly detection.

The output of features F1, F3, F4, F6, F2 and F19 is stored in a foot profile database 406a. The footwear data is stored in a footwear database 406b, and retailer stock is stored in a retailer stock database 406c.

A shoe matching rules engine 408 employs data stored in the foot profile database 406a, the footwear database 406b, and retailer stock database 406c to perform: F9—Matching for foot profile and shoe in stock 406a using retailer ID; F10—matching for foot profile and shoe anywhere without retailer ID; F11—select shoe fit probability with shoe ID; F12—receive profile footwear preferences; and F13—Processing user feedback.

A profile background processing engine 410 is communicatively coupled to the shoe matching rules engine 408 to perform: F7—Risk calculation shoe size; F8—Risk calculation footwear; F14—Age-gender detection; F15—Longitudinal assessment; F16—Growth benchmarking; F17—Profile classification and benchmarking; and F18—Consumer segmentation. The profile background processing engine 410 is further communicatively coupled to a notification engine 412 which perform: F20—Marketing moments—Retarget.

The profile background processing engine 410 and the shoe matching rules engine 408 are communicatively coupled to a retail data and insights module 414, which perform: F20—Retail KPI Impact, F22—Stock and size recommendations, F23—Broken journey; F24—Calls to action, and F25—retail/omnichannel.

It would be apparent to one of ordinary skill in the art, that features F0-F25 have already been explained with reference to FIGS. 1-3 in some form or another. Therefore, their detailed explanation is omitted herein.

The embodiments in the invention described with reference to the drawings comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. a memory stick or hard disk. The carrier may be an electrical or optical signal which may be transmitted via an electrical or an optical cable or by radio or other means.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiments hereinbefore described but May be varied in both construction and detail.

1. A computer implemented method for dynamically recommending footwear size, comprising:
receiving a plurality of images of a foot of a user during a current scan of the user foot, wherein the scan is performed through a mobile computing device;
analysing the plurality of images to generate a 3D foot profile of the user;
determining a foot size of the user based on the 3D foot profile;
predicting a foot growth pattern of the user, using machine learning techniques based on the 3D foot profile, and user profile from the current and one or more previous scans of the user and one or more other users;
recommending one or more footwear sizes for the user based on at least one of: the foot size and the predicted foot growth pattern, one or more footwear brands, and one or more footwear models; and
predicting a time of next scan of the user based on the recommended footwear size and the predicted foot growth pattern of the user and one or more other users.

2. The computer implemented method as claimed in claim 1 further comprising:
recommending a plurality of footwear to the user by searching in a pre-defined footwear inventory based on the recommended footwear size, the 3D foot profile and the user profile of the user and one or more other users, wherein the plurality of footwear is arranged for viewing by the user in a decreasing order of probability of being a good fit to the foot, and wherein the searching in the pre-defined footwear inventory includes matching a category of the 3D foot profile to one or more footwear brands and models.

3. The computer implemented method as claimed in claim 1 or 2 further comprising recommending the plurality of footwear based on the first through fifth inputs, the first input including the foot size of the user, the second input including dimensions of manufacturer's footwear, the third input including properties of manufacturers' shoes including type, colour, material, brand, id of manufacturer, and inventory data, the fourth input including user profile of the user, including phenotype and preferences including purchase data from activity and feedback of past purchases, and the fifth input including user profile of the one or more other users, including phenotype and preferences including the purchase data from activity and feedback of past purchases.

4. The computer-implemented method as claimed in claim 3, wherein the recommending comprises a first step of employing a feet-shoe dimension matching algorithm based on the first and second inputs to generate a first list of shoe recommendations for the user.

5. The computer-implemented method as claimed in claim 4 further comprising comparing 3D profile of a shoe with the 3D foot profile to generate the first list of shoe recommendations for the user.

6. The computer implemented method as claimed in claim 4, wherein the recommending comprises a second step of employing a profile-shoe matching algorithm based on the third and fourth inputs to reduce down the first list of the shoe recommendations for the user.

7. The computer implemented method as claimed in claim 6, wherein the recommending comprises a third step of querying a user profile model previously trained with the fifth input using clustering-based machine learning techniques to create a structure of user profiles with observations aggregating features of the user phenotype, preferences, feet dimensions and shoes purchasing status, to obtain a list of user profiles ranked by similarity.

8. The computer implemented method as claimed in claim 7, wherein the recommending comprises a fourth step of matching and ranking the reduced first list against the list of user profiles to recommend the plurality of footwear.

9. The computer implemented method as claimed in any preceding claim further comprising predicting the footwear inventory based on the recommended plurality of footwear.

10. The computer implemented method as claimed in any preceding claim, wherein the 3D foot profile includes at least one of: a length, a width, an ankle width, a foot height, and a hallux angle of the foot of the user.

11. The computer implemented method as claimed in any preceding claim, wherein the user profile includes at least one of: the age, the height, the ethnicity, preferences, and the gender.

12. The computer implemented method as claimed in any preceding claim further comprising:
calculating a risk associated with changing footwear size of the user based on the 3D foot profile, and the predicted foot growth pattern, wherein the risk increases with each day subsequent to day of the current scan; and
generating an alert for the user to perform the next scan, when the calculated risk exceeds a predetermined risk threshold.

13. The computer implemented method as claimed in any preceding claim further comprising:
calculating a risk that the user is wearing an incorrectly fitted footwear, based on the worn footwear, 3D foot profile, and the predicted foot growth pattern, wherein the risk increases with each day subsequent to day of the current scan; and
generating an alert for the user when the calculated risk exceeds a predetermined risk threshold.

14. The computer implemented method as claimed in any preceding claim further comprising:
providing a user interface so as to enable the user to provide their feedback; and
processing the feedback to revise the recommended footwear.

15. The computer implemented method as claimed in any preceding claim, further comprising:
performing longitudinal analysis of foot growth between current and next scans to predict foot growth and development of the user; and
detect an anomaly in the foot growth by analysing the foot growth in respect of a 3D foot profile and a footwear size applicable for the age and gender of the user.

16. A system for dynamically recommending footwear size, comprising:
a foot profiling module configured to:
receive a plurality of images of a foot of a user during a current scan of the user foot, wherein the scan is performed through a mobile computing device;
analyse the plurality of images to generate a 3D foot profile of the user; and
determine a foot size of the user based on the 3D foot profile;
a foot growth pattern module configured to:
predict a foot growth pattern of the user using machine learning techniques based on the 3D foot profile, and a user profile from the current and one or more previous scans of the user and one or more other users;
a recommendation module configured to:
recommend one or more footwear sizes for the user based on at least one of: the foot size, the predicted foot growth pattern, one or more footwear brands and one or more footwear models; and
a prediction module configured to:
predict a time of next scan of the user based on the recommended footwear size and the predicted foot growth pattern of the user and one or more other users.

17. The system as claimed in claim 16, wherein the recommendation module is further configured to:
recommend a plurality of footwear to the user by searching in a pre-defined footwear inventory based on the recommended footwear size, the 3D foot profile and the user profile, wherein the plurality of footwear is arranged for viewing by the user in a decreasing order of probability of being a good fit to the foot, and wherein the searching in the pre-defined footwear inventory includes matching a category of the 3D foot profile to one or more footwear brands and models.

18. The system as claimed as claimed in claim 16 further comprising:
a risk calculation module that is configured to:
calculate a risk that the user is wearing an incorrectly fitted footwear, based on the worn footwear, 3D foot profile, and the predicted foot growth pattern, wherein the risk increases with each day subsequent to day of the current scan; and
calculate a risk associated with changing footwear size of the user based on the 3D foot profile, and the predicted foot growth pattern, wherein the risk increases with each day subsequent to day of the current scan; and
a notification module that is configured to:
generate an alert for the user when the calculated risk exceeds a predetermined risk threshold.

19. The system as claimed as claimed in claim 16, wherein:
the foot growth pattern module is further configured to:
perform longitudinal analysis of foot growth between current and next scans to predict foot growth and development of the user; and
the risk calculation module is further configured to:
detect an anomaly in the foot growth by analysing the foot growth in respect of a 3D foot profile and a footwear size applicable for the age and gender of the user.

20. A non-transitory computer readable medium having stored thereon computer-executable instructions which, when executed by a processor, cause the processor to:
receive a plurality of images of a foot of a user during a current scan of the user foot, wherein the scan is performed through a mobile computing device;
analyse the plurality of images to generate a 3D foot profile of the user;
determine a foot size of the user based on the 3D foot profile;
predict a foot growth pattern of the user, using machine learning techniques based on the 3D foot profile, and a user profile from the current and one or more previous scans of the user and one or more other users recommend one or more footwear sizes for the user based on at least one of: the foot size, the predicted foot growth pattern, one or more footwear brands and one or more footwear models; and
predict a time of next scan of the user based on the recommended footwear size and the predicted foot growth pattern of the user and one or more other users.
